(19) United States
(12) Patent Application Publication
(10) Pub. No.: US 2015/0349891 A1
(43) Pub. Date: Dec. 3, 2015

(54) APPARATUS AND METHOD FOR MANAGING MULTI-WAVELENGTH RESOURCE OF SEPARATE-TYPE BASE STATION OPTICAL LINK

(71) Applicant: ELECTRONICS AND TELECOMMUNICATIONS RESEARCH INSTITUTE, Daejeon-si (KR)

(72) Inventors: Eui Suk JUNG, Daejeon (KR); Eun Gu LEE, Daejeon (KR); Sang Soo LEE, Daejeon (KR)

(21) Appl. No.: 14/720,210

(22) Filed: May 22, 2015

(30) Foreign Application Priority Data
May 27, 2014 (KR) 10-2014-0064020

(51) Int. Cl. H04B 10/2575

(52) U.S. Cl. CPC H04B 10/25753

(57) ABSTRACT

The present disclosure provides a digital unit including: one or more remote apparatus communicators configured to correspond to each of one or more remote apparatuses to process transmitted and received data; a multi-wavelength controller configured to convert data transmitted from each of the one or more remote apparatuses into a wavelength allocated thereto and to transmit the converted data to remote apparatuses via an optical fiber; and a base station controller configured to allocate transmission and reception wavelength to each of the one or more remote apparatus communicators to control the multi-wavelength controller and to transmit wavelength information associated with the wavelength allocation to each of the one or more remote apparatuses.

### CROSS-REFERENCE TO RELATED APPLICATIONS

This application claims priority from Korean Patent Application No. 10-2014-0064020, filed on May 27, 2014, in the Korean Intellectual Property Office, the entire disclosure of which is incorporated herein by reference for all purposes.

### BACKGROUND

1. Field

The following description generally relates to a separate-type base station apparatus that is located and operated remotely from a base station, and more particularly to an apparatus and method for managing multi-wavelength resources of a separate-type base station optical link.

2. Description of the Related Art

Separate-type base stations for mobile communications are operated by separately using apparatuses located at base stations (hereinafter referred to as “digital unit” and apparatuses located at remote places (hereinafter referred to as “remote apparatus”), in which the digital unit and the remote apparatus are connected via an optical fiber. That is, the remote apparatus is located at the side of a terminal of a wireless subscriber and processes wireless signals, and the digital unit is connected to the remote apparatus via an optical fiber, and processes digital signals.

In most separate-type base stations, each remote apparatus is separately connected to a digital unit via a communication optical fiber. For this reason, as the number of remote apparatuses is increased, costs of installation and maintenance of optical fibers are also increased. To solve this problem, a method has been suggested in which one digital unit is connected to one remote apparatus using one optical link, including a one-on-one connection of remote apparatuses located at a remote place. However, the method is performed by time-dividing data transmission amounts into a number of remote apparatuses, such that data may be transmitted only when the remote apparatuses are used, and cannot be transmitted at other times, thereby causing transmission delay.

### SUMMARY

The present disclosure provides an apparatus and method for managing multi-wavelength resources of a separate-type base station optical link, in which installation costs may be reduced by reducing demands for installing optical fibers that are required to connect a plurality of remote apparatuses, and remote apparatuses may be operated without limitation in transmission amounts by separately allocating optical wavelengths for each remote apparatus.

Further, in the present disclosure, by collecting an optical wavelength from a remote apparatus with a reduced usage rate and reallocating the collected optical wavelength to other remote apparatuses, wavelength resources may be used efficiently, and power consumption of idle remote apparatuses may be reduced.

In one general aspect, there is provided a digital unit, including: one or more remote apparatus communicators configured to correspond to each of one or more remote apparatuses to process transmitted and received data; a multi-wavelength controller configured to convert data transmitted from each of the one or more remote apparatuses into a wavelength allocated thereto and to transmit the converted data to remote apparatuses via an optical fiber; and a base station controller configured to allocate transmission and reception wavelength to each of the one or more remote apparatus communicators to control the multi-wavelength controller and to transmit wavelength information associated with the wavelength allocation to each of the one or more remote apparatuses.

In another general aspect, there is provided a remote apparatus, including: a wavelength control information processor configured to receive wavelength length allocation information from a digital unit; a remote base station communicator configured to process data to be transmitted to and received from the digital unit; a remote apparatus wavelength optical input and output component configured to determine a wavelength to be used for transmission and reception with the digital unit; and a remote apparatus controller configured to control the remote base station communicator or the remote apparatus wavelength optical input and output component according to the received wavelength allocation information.

In yet another general aspect, there is provided a method of managing multi-wavelength resources of a separate-type base station optical link, the method performed by a digital unit and including: monitoring a threshold of a reference parameter according to an operation policy; in response to the monitored threshold being greater than a threshold used to determine whether to additionally allocate a wavelength, determining whether there is an idle wavelength for optical transmission and reception; and in response to a determination that there is an idle wavelength for optical transmission and reception, transmitting information for controlling wavelength allocation to a remote apparatus.

### BRIEF DESCRIPTION OF THE DRAWINGS

FIG. 1 is a diagram illustrating an example of a separate-type base station.

FIG. 2 is a diagram illustrating an example of a separate-type base station in which one digital unit is connected to a plurality of remote apparatuses.

FIG. 3 is a diagram illustrating an example of a separate-type base station in which one digital unit is connected to a plurality of remote apparatuses in a chain-type connection.

FIG. 4 is a diagram illustrating an example of a separate-type base station in which one digital unit is connected to a plurality of remote apparatuses in a ring-type connection.

FIG. 5 is a block diagram illustrating an internal structure of a digital unit according to an exemplary embodiment.

FIG. 6 is a block diagram illustrating a wavelength-fixed type multi-wavelength controller according to an exemplary embodiment.

FIG. 7 is a block diagram illustrating a wavelength-tunable type multi-wavelength controller according to another exemplary embodiment.

FIG. 8 is a flowchart explaining a method of managing multi-wavelength resources of a separate-type base station optical link according to an exemplary embodiment.

FIG. 9 is a diagram illustrating a scenario of managing optical wavelength resources to which the present disclosure is applied.

FIG. 10 is a diagram illustrating a remote apparatus according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

In the following description, well-known functions or constructions are not described in detail since they would obscure the invention in unnecessary detail.

The terms used herein are defined in consideration of the functions of elements in the present invention, and can be varied according to a purpose of a user or manager, or precedent and so on. Therefore, definitions of the terms should be made on the basis of the overall context.

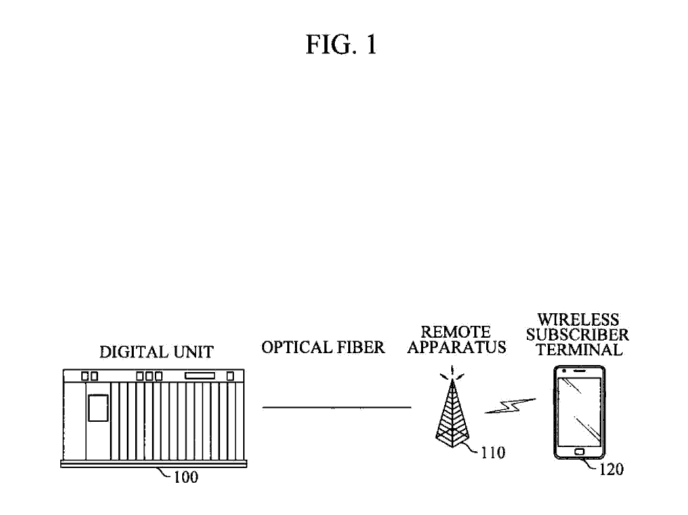

FIG. 1 is a diagram illustrating an example of a separate-type base station.

Referring to FIG. 1, the separate-type base station for mobile communications is operated by separately using an apparatus 100 located at a base station (hereinafter referred to as a “digital unit”) and an apparatus 110 located at a remote place (hereinafter referred to as a “remote apparatus”), in which the digital unit 100 and the remote apparatus 110 are connected via an optical fiber, and operations thereof are as follows.

The remote apparatus 110 is located at the side of a terminal 120 of a wireless subscriber and processes wireless signals, and the digital unit 100 is connected to the remote apparatus 110 via an optical fiber and processes digital signals. In the present disclosure, functions of the digital unit 100 and the remote apparatus 110 are separated so that different optical wavelengths for communications may be allocated or reallocated to, and collected from each remote apparatus.

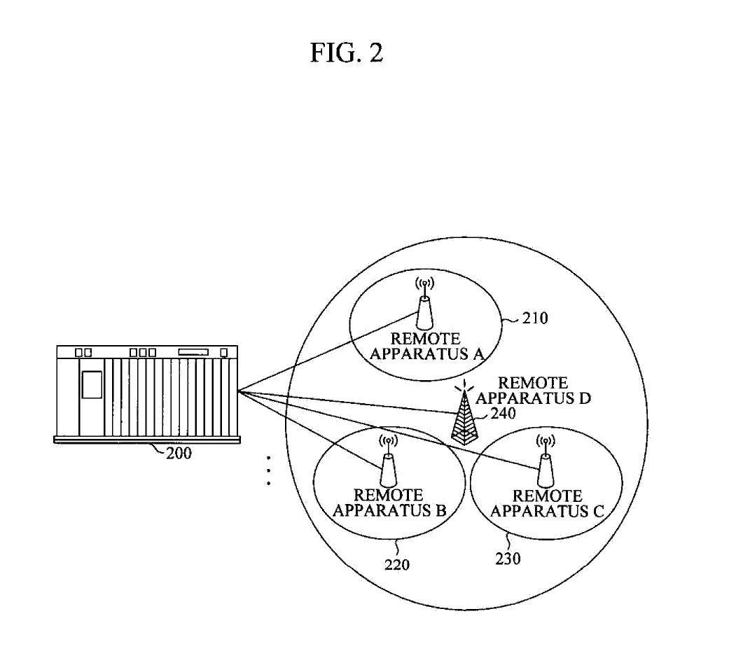

FIG. 2 is a diagram illustrating an example of a separate-type base station in which one digital unit is connected to a plurality of remote apparatuses.

Referring to FIG. 2, in most separate-type base stations, remote apparatus A 210, remote apparatus B 220, remote apparatus C 230, and remote apparatus D 240 are connected to a digital unit 200 via a communication optical fiber. For this reason, as the number of remote apparatuses is increased, costs of installation and maintenance of optical fibers are also increased. The problem may be solved by the following method.

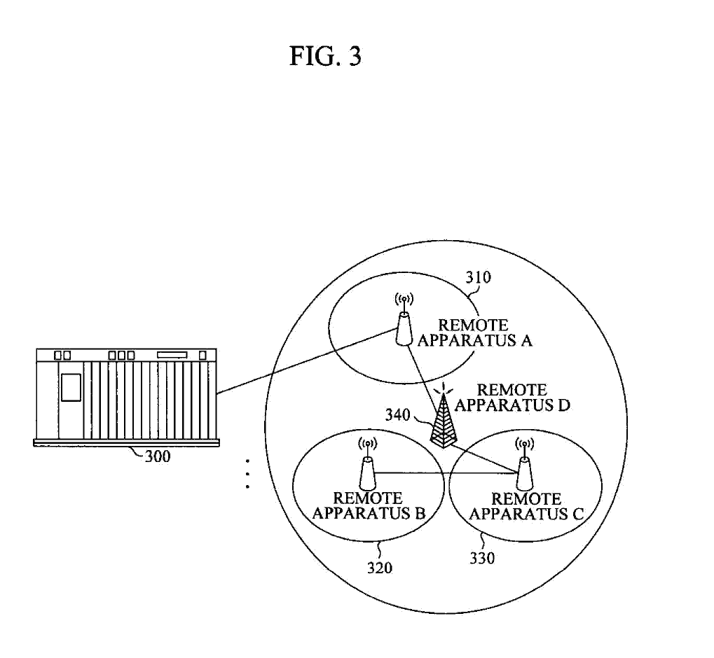

FIG. 3 is a diagram illustrating an example of a separate-type base station in which one digital unit is connected to a plurality of remote apparatuses in a chain-type connection.

Referring to FIG. 3, a digital unit 300 is connected to only one remote apparatus 310 via one optical link, or alternatively, remote apparatuses 310, 320, 330, and 340 are connected to each other one-on-one. However, the method is implemented by time-dividing data transmission amounts into the number of the remote apparatuses 310, 320, 330, and 340, such that data may be transmitted only when the remote apparatuses are used, and cannot be transmitted at other times, thereby causing transmission delay.

In order to solve the above problem, the present disclosure provides an apparatus and method that may reduce installation costs by reducing demands for installing optical fibers that are required to connect a plurality of remote apparatuses, and remote apparatuses may be operated without limitation in transmission amounts by separately allocating optical wavelengths for each remote apparatus.

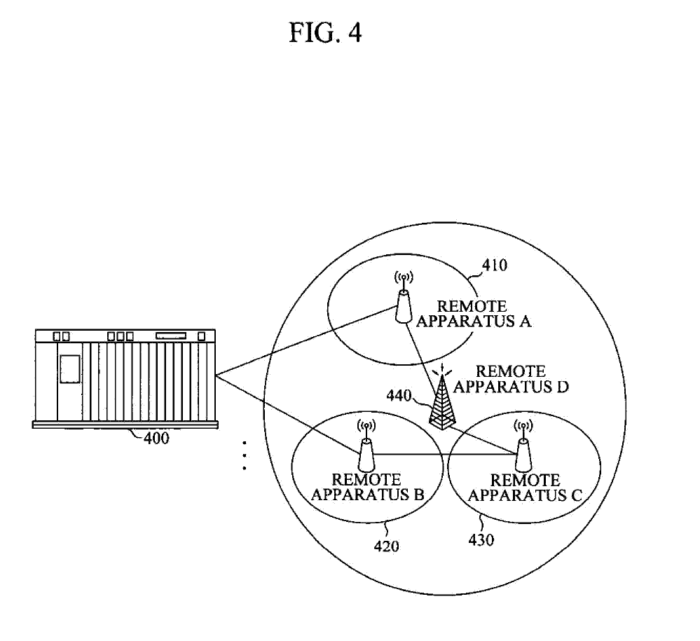

In the apparatus and method for managing multi-wavelength resources of a separate-type base station optical link, the digital unit enables a connection illustrated in FIG. 2, a chain-type connection illustrated in FIG. 3, and a ring-type connection illustrated in FIG. 4; and the method relates to a method of managing multi-wavelength resources, which includes allocating, collecting, and reallocating multi-wavelength channels between a digital unit and each remote apparatus.

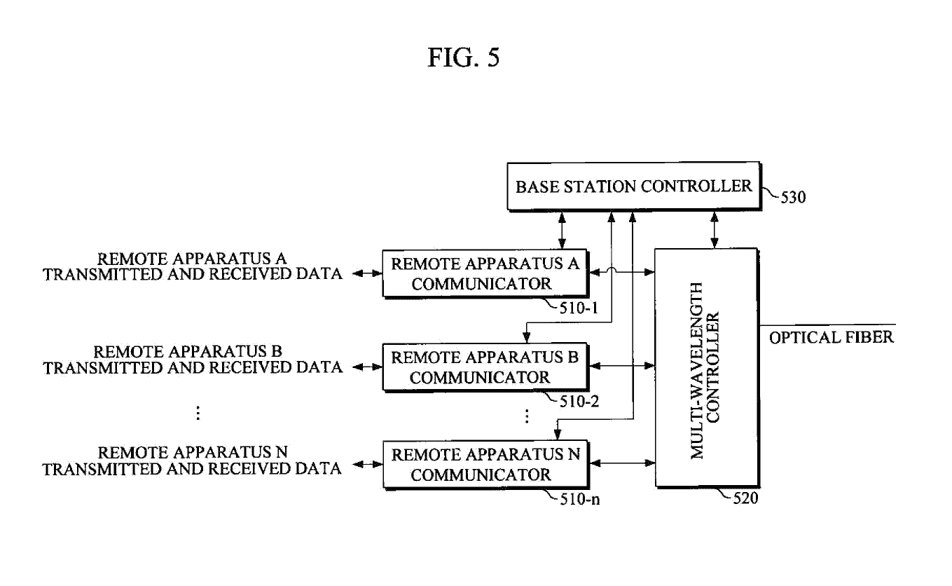

FIG. 5 is a block diagram illustrating an internal structure of a digital unit according to an exemplary embodiment.

Referring to FIG. 5, remote apparatus communicators 510-1, 510-2, . . . , and 510-n process data to be transmitted and received to/from a remote apparatus which is connected to the remote apparatus communicator, and receive data to be transmitted from a multi-wavelength controller 520 to an optical fiber, or a signal received by the multi-wavelength controller 520 via the optical fiber. The remote apparatus communicators 510-1, 510-2, . . . , and 510-n are controlled by a base station controller 530.

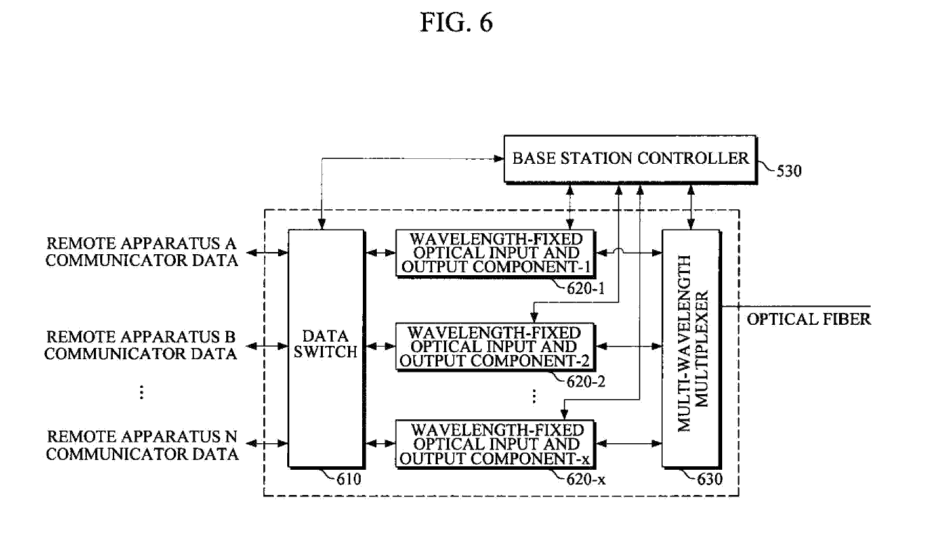

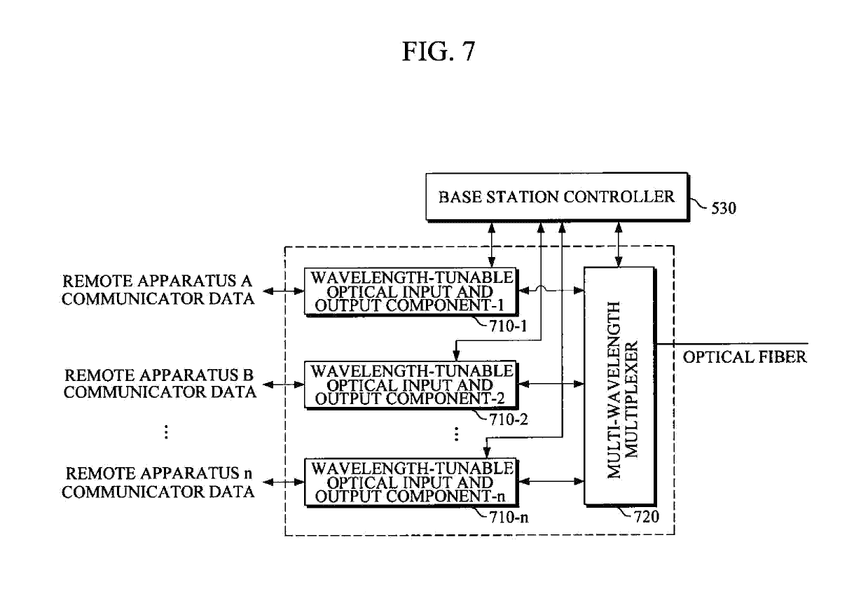

The base station controller 530 controls a multi-wavelength controller 520 to determine a wavelength into which data transmitted and received to/from remote apparatus communicators 510-1, 510-2, . . . , and 510-n is to be converted, and to determine a remote apparatus to which the converted data is to be transmitted via an optical fiber. The multi-wavelength controller 520 may include a wavelength-fixed type optical device or a wavelength-tunable type optical device, which will be described in detail with reference to FIGS. 6 and 7.

FIG. 6 is a block diagram illustrating a wavelength-fixed type multi-wavelength controller according to an exemplary embodiment.

Referring to FIG. 6, the wavelength-fixed type multi-wavelength controller connects each of the remote apparatus communicators 510-1, 510-2, . . . , and 510-n to a data switch 610, and transmits and receives data to/from the remote apparatus communicators 510-1, 510-2, . . . , and 510-n using a fixed wavelength of wavelength-fixed optical input and output components 620-1, 620-2, . . . , and 620-x.

Each of the wavelength-fixed optical input and output components 620-1, 620-2, . . . , and 620-x has an output optical wavelength and an input optical wavelength that are fixed at specific wavelengths, and the base station controller 530 may turn on a wavelength-fixed optical input and output component corresponding to the optical wavelength when the wavelengths are necessary, and may turn off the optical wavelengths when the wavelengths are not used.

A multi-wavelength multiplexer 630 performs multiplexing (MUX) or demultiplexing (DEMUX) of operation wavelengths processed by the wavelength-fixed optical input and output components 620-1, 620-2, . . . , and 620-x.

FIG. 7 is a block diagram illustrating a wavelength-tunable type multi-wavelength controller according to another exemplary embodiment.

Referring to FIG. 7, the wavelength-tunable type multi-wavelength controller performs: an optical output function in which wavelength-tunable optical input and output components 710-1, 710-2, . . . , 710-x convert data into optical wavelengths; and an optical receiving function of selecting a specific optical wavelength from among various input wavelengths and receiving the selected wavelength. The base station controller 530 determines a wavelength for output, a wavelength for, input, or whether to turn on or off an optical input function and an optical output function.

A multi-wavelength multiplexer 720 performs the same function as in the wavelength-fixed type multi-wavelength controller.

The base station controller 530 transmits a control signal of, for example, allocating, collecting, and reallocating wavelengths, and halting the function of remote apparatuses, to the remote apparatus communicators 510-1, 510-2, . . . , and 510-n and to the multi-wavelength controller 520. In addition, control information regarding input and output optical wavelengths or halting the function of remote apparatuses may be transmitted by a wavelength-tunable input and output components 710-1, 710-2, . . . , 710-x and the multi-wavelength multiplexer 720.

Examples of parameters that may be used when an operator determines a wavelength operation policy are as follows, and ranges and values of parameters, parameters to be combined, or the like may be determined according to the operation policy.

a) the number of connected wireless terminals

b) average traffic of connected terminals

c) real-time traffic

d) operation statistics of each event on a daily, monthly, weekday, or weekend basis, on a daytime or night time basis, on a seasonal basis, on a yearly basis, on a holiday basis, and the like.

e) used wavelengths and idle wavelengths resources

Control signals of allocating, collecting, and reallocating wavelengths, or halting the function of remote apparatuses may be transmitted from the base station controller 530 to remote apparatuses by using an in-band method of including values in operation packets or fields, or by using an out-of-band method of separately managing wavelengths for operations.

In addition, in the case where the multi-wavelength controller 520 is of a wavelength-fixed type, the base station controller 530 may control data switch path information, and in the case where the multi-wavelength controller 520 is of a wavelength-tunable type, the base station controller 530 may control wavelength control information of the wavelength-tunable optical input and output components 710-1, 710-2, . . . , 710-x.

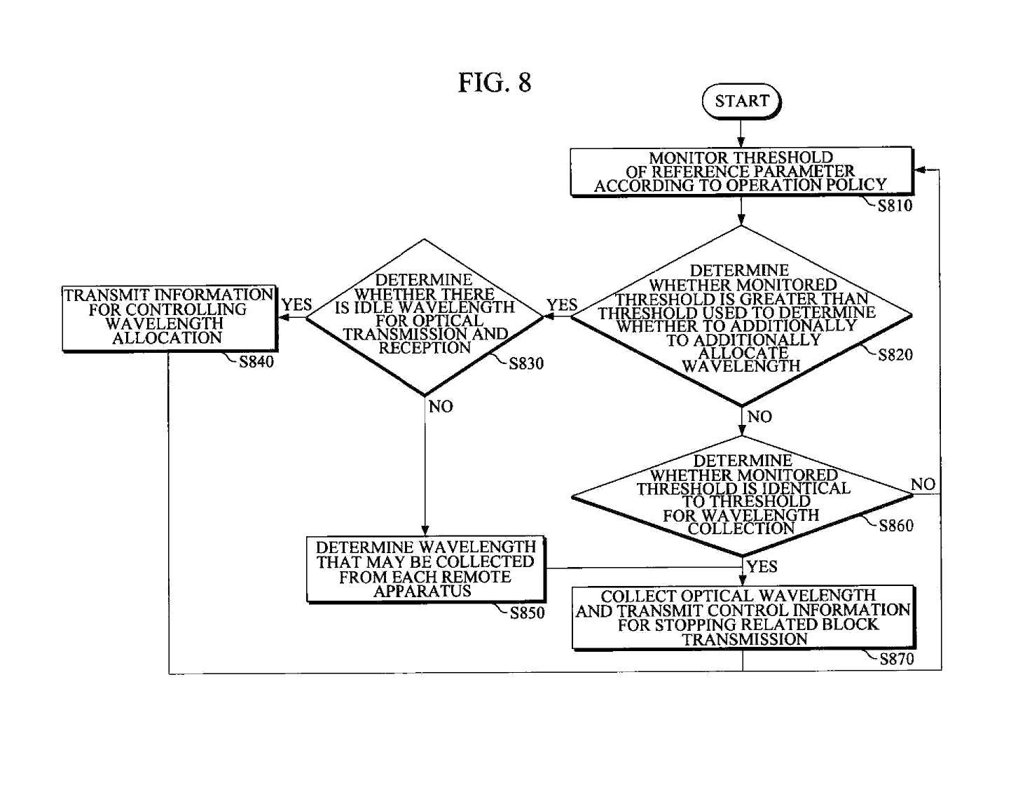

FIG. 8 is a flowchart explaining a method of managing multi-wavelength resources of a separate-type base station optical link according to an exemplary embodiment.

Referring to FIG. 8, the base station controller 530 monitors a threshold of a reference parameter according to an operation policy in S810. Further, the base station controller 530 determines in S820 whether the monitored threshold is greater than a threshold used to determine whether to additionally allocate a wavelength.

Upon determination in S820, if the monitored threshold is greater than a threshold used to determine whether to additionally allocate a wavelength, the base station controller 530 determines in S830 whether there is an idle wavelength for optical transmission and reception. Upon determination in S830, if there is an idle wavelength for optical transmission and reception, the base station controller 530 transmits information for controlling wavelength allocation in S840. By contrast, if it is determined in S830 that there is no idle wavelength for optical transmission and reception, the base station controller 530 determines a wavelength that may be collected from each remote apparatus in S850.

If it is determined in S820 that the monitored threshold is not greater than a threshold used to determine whether to additionally allocate a wavelength, the base station controller 530 determines in S860 whether the monitored threshold is identical to a threshold for wavelength collection. Upon determination in S860, if the monitored threshold is identical to a threshold for wavelength collection, the base station controller 530 collects the optical wavelength in S870, and transmits control information for halting related block transmission.

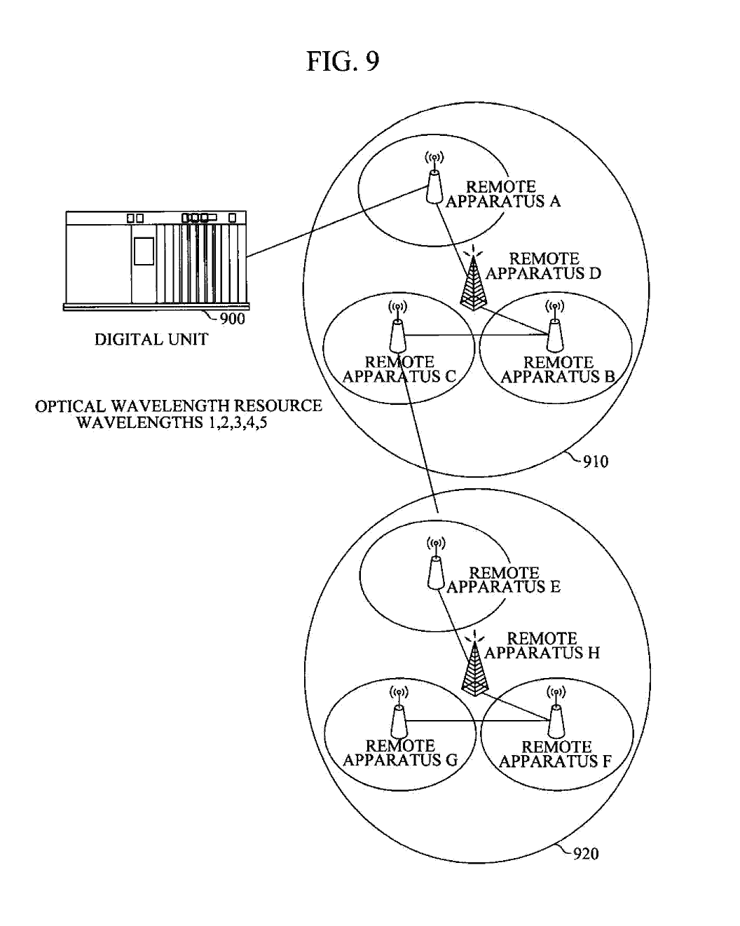

FIG. 9 is a diagram illustrating a scenario of managing optical wavelength resources to which the present disclosure is applied.

FIG. 9 illustrates an example of allocating, collecting, and reallocating wavelengths, or halting the function of remote apparatuses in the case where there are remote apparatuses A, B, C, D, E, F, G, and H, in which macro remote apparatuses D and H have a wide frequency power range, and remote apparatuses A, B, C, E, F, and G, although having a smaller radio radius, are used when it is desired to accommodate as many wireless terminals as possible and to increase frequency reusability; and a digital unit that is connected to the remote apparatuses has six optical wavelengths 1, 2, 3, 4, 5, and 6 as wavelength resources.

Assuming that many users are in commercial areas during a daytime, the function of remote apparatuses A, B, and C is halted with no wavelength being allocated thereto, and wavelength 1 is allocated only to remote apparatus D. Wavelengths 2, 3, and 4 are allocated to remote apparatuses E, F, and G respectively in commercial areas where there are many users, and the function of remote apparatus H is halted with no wavelength being allocated thereto.

By contrast, during a night time, assuming that many users are in residential areas, remote apparatuses A, B, C, and H are turned on, and remote apparatuses D, E, F, and G are turned off to reallocate their wavelengths, idle wavelength 5 is allocated to remote apparatus A. As there is no idle wavelength in remote apparatus B, wavelengths 2, 3, and 4 allocated to remote apparatuses E, F, and G are collected, and the function of the remote apparatuses, from which wavelengths have been collected, is halted. Further, wavelength 2 secured by the collection is allocated to turn on remote apparatus H. The collected wavelengths 3 and 4 are allocated to remote apparatuses B and C respectively.

The example of allocating, collecting, and reallocating wavelengths, and halting the function of remote apparatuses is merely an illustrative embodiment, and cell radius operations of remote apparatuses, radio frequency resources, numbers and sequence of allocating wavelengths, and the like conform to an operation policy, and thus are not beyond the spirit and scope of the present disclosure.

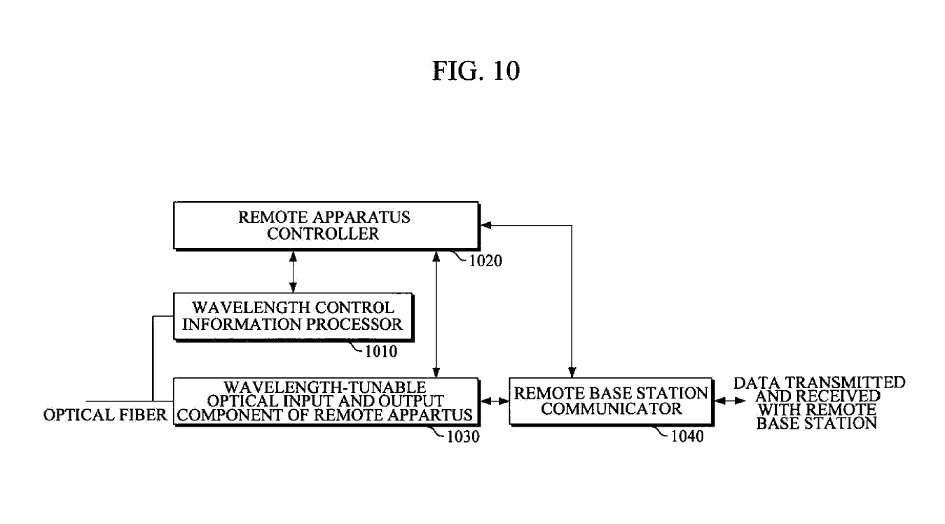

FIG. 10 is a diagram illustrating a remote apparatus according to an exemplary embodiment.

Referring to FIG. 10, when the above-described digital unit transmits, by an out-of-band method, information on wavelength allocation and control of remote apparatuses, and the like, a wavelength control information processor 1010 receives related information through a link and transmits the received information to a remote apparatus controller. In the case of using an in-band method, there is no need for the wavelength control information processor 1010.

Upon receiving the control information, once a remote apparatus controller 1020 transmits an instruction to other block and the block completes the instruction, the remote apparatus controller 1020 may directly transmit, to the digital unit, a confirmation message including information associated with the completed instruction, or may transmit the message by using a wavelength-tunable optical output function of the remote apparatus through the remote base station communicator 1030. Even in the case where the function of the remote apparatus is halted as a wavelength of the remote apparatus is collected, the remote apparatus is required to monitor whether control information is transmitted from the digital unit.

The remote apparatus controller 1020 receives, from an out-of-band wavelength control information processor, wavelength-tunable optical input and output component of remote apparatuses, or remote base station communicator 1040, wavelength control information transmitted from the digital unit by an out-of-band or in-band method. Then, the remote apparatus controller 1020 controls each block by determining a wavelength to be used to perform optical transmission or reception with the station apparatus, or determining whether to halt the function of remote apparatuses.

A wavelength-tunable optical input and output component 1030 of remote apparatuses determines a setting for optical transmission and reception according to an optical wavelength for transmission and reception with a digital unit, in which the optical wavelength is informed by the remote apparatus controller 1020. The optical output includes a wavelength tuning function, and the optical input includes a wavelength selecting function. Further, even when remote apparatuses are operated by an out-of-band method, the wavelength-tunable optical input and output component 1030 of remote apparatuses may temporarily function as the wavelength control information processor 1010 as long as the function does not affect wavelength-tunable optical input and output data of the remote apparatuses, such that a required number of blocks may be reduced.

A remote base station communicator 1040 processes data that remote apparatuses transmit and receive to/from the digital unit. That is, in the case where the digital unit manages wavelength control information by an in-band method, the remote base station communicator 1040 extracts the control information and transmits the information to the remote apparatus controller 1020, and the remote apparatus controller 1020 transmits state information and the like by an in-band method to the base station controller 530 of the digital unit.

In the present disclosure, by reducing costs of installation and maintenance of optical fibers that connect a plurality of remote apparatuses used in the related art, and by allocating an optical wavelength for each remote apparatus, remote apparatuses may be operated without limitation in transmission amounts. Further, by collecting an optical wavelength from a remote apparatus with a reduced usage rate, and by allocating the collected optical wavelength to other remote apparatuses optical wavelength resources may be used efficiently, and power consumption of an idle remote apparatus may be reduced. In addition, the present disclosure provides various and flexible optical link connections.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital unit comprising:
one or more remote apparatus communicators configured to correspond to each of one or more remote apparatuses to process transmitted and received data;
a multi-wavelength controller configured to convert data transmitted from each of the one or more remote apparatuses into a wavelength allocated thereto and to transmit the converted data to remote apparatuses via an optical fiber; and
a base station controller configured to allocate transmission and reception wavelength to each of the one or more remote apparatus communicators to control the multi-wavelength controller and to transmit wavelength information associated with the wavelength allocation to each of the one or more remote apparatuses.

2. The apparatus of claim 1, wherein the multi-wavelength controller comprises:
a data switch configured to switch one of the one or more remote apparatus communicators;
one or more wavelength-fixed optical input and output component configured to transmit and receive data to/from the remote apparatuses through a fixed wavelength, the data being transmitted from a remote apparatus communicator that has been switched on by the data switch; and
a multi-wavelength multiplexer configured to multiplex or demultiplex an operation wavelength that is processed by the one or more wavelength fixed optical input and output component.

3. The apparatus of claim 1, wherein the multi-wavelength controller comprises:
one or more wavelength-tunable optical input and output component configured to correspond to the one or more remote apparatus communicators and to convert data transmitted from the one or more remote apparatus communicator into an optical wavelength selected by the base station controller to transmit the converted data and
a multi-wavelength multiplexer configured to multiplex or demultiplex an operation wavelength that is processed by the one or more wavelength fixed optical input and output component.

4. The apparatus of claim 3, wherein when determining a wavelength operation policy of an operator, the base station controller determines ranges and values of parameters, and parameters to be combined according to the operation policy.

5. The apparatus of claim 4, wherein the parameters comprise at least one or more of the following: the number of connected wireless terminals; average traffic of connected terminals; real-time traffic; operation statistics of each event on a daily, monthly, weekday, or weekend basis, on a daytime or night time basis, on a seasonal basis, on a yearly basis, on a holiday basis; and used wavelengths and idle wavelengths resources.

6. The apparatus of claim 1, wherein the base station controller transmits control signals of allocating, collecting, and reallocating wavelengths, or halting the function of remote apparatuses to remote apparatuses by using an in-band method of including values in operation packets or fields, or by using an out-of-band method of separately managing wavelengths for operations.

7. The apparatus of claim 1, wherein the base station controller monitors a threshold of a reference parameter according to the operation policy, wherein in response to the monitored threshold being greater than a threshold used to determine whether to additionally allocate a wavelength, the base station controller determines whether there is an idle wavelength for optical transmission and reception, and in response to a determination that there is an idle wavelength for optical transmission and reception, the base station controller transmits information for controlling wavelength allocation.

8. The apparatus of claim 7, wherein in response to a determination that there is no idle wavelength for optical transmission and reception, the base station controller determines a wavelength capable of being collected from each remote apparatus.

9. The apparatus of claim 7, wherein in response to the monitored threshold not being greater than the threshold used to determine whether to additionally allocate a wavelength, the base station controller determines whether the monitored threshold is identical to a threshold for wavelength collection, and in response to a determination that the monitored threshold is identical to the threshold for wavelength collection, the base station controller collects a wavelength and transmits control information for halting related block transmission.

10. A remote apparatus comprising:
a wavelength control information processor configured to receive wavelength length allocation information from a digital unit,
a remote base station communicator configured to process data to be transmitted to and received from the digital unit;
a remote apparatus wavelength optical input and output component configured to determine a wavelength to be used for transmission and reception with the digital unit; and
a remote apparatus controller configured to control the remote base station communicator or the remote apparatus wavelength optical input and output component according to the received wavelength allocation information.

11. The apparatus of claim 10, wherein after completing the control according to the wavelength allocation information, the remote apparatus controller transmits a confirmation message to the digital unit.

12. The apparatus of claim 11, wherein the remote apparatus controller receives, from the remote apparatus wavelength-tunable optical input and output component, the wavelength control information transmitted from the digital unit by an in-band method.

13. The apparatus of claim 12, wherein after completing the control according to the wavelength allocation information, the remote apparatus controller transmits a confirmation message to the digital unit by an in-band method.

14. A method of managing multi-wavelength resources of a separate-type base station optical link, the method performed by a digital unit and comprising:
monitoring a threshold of a reference parameter according to an operation policy;
in response to the monitored threshold being greater than a threshold used to determine whether to additionally allocate a wavelength, determining whether there is an idle wavelength for optical transmission and reception; and
in response to a determination that there is an idle wavelength for optical transmission and reception, transmitting information for controlling wavelength allocation to a remote apparatus.

15. The method of claim 14, wherein in response to a determination that there is no idle wavelength for optical transmission and reception, determining a wavelength capable of being collected from each remote apparatus.

16. The method of claim 14, comprising: in response to the monitored threshold not being greater than the threshold used to determine whether to additionally allocate a wavelength, the base station controller, determining whether the monitored threshold is identical to a threshold for wavelength collection; and
in response to a determination that the monitored threshold is identical to the threshold for wavelength collection, collecting a wavelength and transmitting control information for halting related block transmission.
